(19) United States
(12) Patent Application Publication
(10) Pub. No.: US 2025/0126435 A1
(43) Pub. Date: Apr. 17, 2025

(54) COMMERCIAL EQUIPMENT LOCATION AND STATUS TRACKER

(71) Applicant: Ribbiot, Inc., Huntington Beach, CA (US)

(72) Inventors: Joseph Frigo, Huntington Beach, CA (US); Branden Sheffield, Saratoga Springs, UT (US)

(73) Assignee: Ribbiot, Inc., Huntington Beach, CA (US)

(21) Appl. No.: 18/487,867

(22) Filed: Oct. 16, 2023

(51) Int. Cl. H04W 4/029; G01S 19/01; H04W 76/14

(52) U.S. Cl. CPC H04W 4/029; G01S 19/01; H04W 76/14

(57) ABSTRACT

A commercial equipment tracker tracking pod data via BLE, NFC, UWB, and/or other communications protocols. BLE interfaces with a user device to provide location data for the commercial equipment while NFC provides associated user devices with status information about the equipment. The tracking pod may be configured to couple to the commercial equipment via a housing. The tracking pod may also be configured with various sensors to allow for the tracking of the operation of the commercial equipment and, thus, allow for updates to the status of the commercial equipment based on the tracking.

### FIELD OF TECHNOLOGY

This patent application relates generally to electronic devices, and more specifically to commercial equipment tracking devices.

### BACKGROUND

Commercial assets, such as equipment used on jobsites, is often critical to projects. Due to the expense of various assets, such assets are often shared between jobsites. Accordingly, the timely delivery of such equipment is often critical to projects being performed on time and within budget. Scheduling of assets shared between jobsites, and making sure that such assets arrive as scheduled, are critical to efficient company operations and successful businesses.

### SUMMARY

Described are methods and systems for commercial equipment tracking. In a certain embodiment, a commercial equipment tracking system is described.

Clause 1: A commercial equipment tracking system, comprising: a tracking pod, comprising: a pod body, configured to be coupled to commercial equipment; a first communications module, disposed within the pod body and configured to connect with a user device to provide equipment data to the user device, wherein the first communications module comprises an ultra-wideband (UWB) module; a near-field communications module, disposed within the pod body and configured to communicatively couple with the user device when the user device is disposed within a short range of the tracking pod; and a battery configured to power the first communications module and/or the near-field communications module.

Clause 2: The commercial equipment tracking system of clause 1, wherein the pod body is configured to couple to the commercial equipment via a pod housing.

Clause 3. The commercial equipment tracking system of clause 2, wherein the pod body is configured to be disposed within a cavity of the pod housing.

Clause 4. The commercial equipment tracking system of clause 2, further comprising: the pod housing.

Clause 5. The commercial equipment tracking system of clause 4, wherein the pod housing is configured to fully surround a perimeter of the pod body.

Clause 6. The commercial equipment tracking system of clause 1, wherein the equipment data is configured to cause the user device to provide location data to a server device.

Clause 7. The commercial equipment tracking system of clause 1, wherein the equipment data is configured to allow the user device to identify the commercial equipment.

Clause 8. The commercial equipment tracking system of clause 1, wherein the first communications module is configured to connect to a plurality of user devices.

Clause 9. The commercial equipment tracking system of clause 8, wherein the first communications module is configured to provide equipment data to each of the plurality of user devices.

Clause 10. The commercial equipment tracking system of clause 9, wherein the providing the equipment data to each of the plurality of user devices allows triangulation to be performed to determine the location of the tracking pod.

Clause 11. The commercial equipment tracking system of clause 1, wherein the first communications module further comprises a Bluetooth Low Energy (BLE) module.

Clause 12. The commercial equipment tracking system of clause 1, further comprising: a sensor, configured to provide sensor data; and a memory, configured to receive and store the sensor data.

Clause 13. The commercial equipment tracking system of clause 1, wherein the near-field communications module is configured to provide equipment data to the user device.

Clause 14. The commercial equipment tracking system of clause 13, wherein the equipment data is configured to cause the user device to communicate device information.

Clause 15. The commercial equipment tracking system of clause 1, wherein the tracking pod further comprises: a global-positioning system (GPS) module, configured to receive location data from one or more GPS satellites.

Clause 16. The commercial equipment tracking system of clause 15, wherein the tracking pod further comprises: a cellular module, configured to provide the location data to the user device.

Clause 17. The commercial equipment tracking system of clause 1, further comprising: a battery voltage monitor, configured to determine a state of charge of the battery based on: a voltage change of the battery during a communications event of the first communications module; a current of the battery during the communications event of the first communications module; and a temperature of the battery.

Clause 18. The commercial equipment tracking system of clause 1, further comprising: a server device, configured to receive equipment data associated with a plurality of commercial equipment from a plurality of user devices associated with a plurality of tracking pods.

Clause 19. The commercial equipment tracking system of clause 18, wherein the server device is further configured to: determine, based on the equipment data, current locations for each of the commercial equipment.

Clause 20. The commercial equipment tracking system of clause 19, wherein the server device is further configured to: determine, based on the current locations of the commercial equipment, an equipment schedule.

These and other examples are described further below with reference to figures.

### BRIEF DESCRIPTION OF THE DRAWINGS

The included drawings are for illustrative purposes and serve only to provide examples of possible structures and operations for the disclosed inventive systems, apparatus, methods, and computer program products for commercial equipment tracking. These drawings in no way limit any changes in form and detail that may be made by one skilled in the art without departing from the spirit and scope of the disclosed implementations.

FIG. 1 illustrates a block diagram of an example system, in accordance with some embodiments.

FIG. 2 illustrates a perspective view of a commercial equipment tracking assembly, in accordance with some embodiments.

FIG. 3 illustrates an exploded view of a commercial equipment tracking device, in accordance with some embodiments.

FIG. 4 illustrates an exploded view of components of a commercial equipment tracking assembly, in accordance with some embodiments.

FIG. 5 illustrates a block diagram of an example computing system, in accordance with some embodiments.

FIG. 6 illustrates a commercial equipment tracking device affixed to commercial equipment, in accordance with some embodiments.

FIG. 7 illustrates a graphical user interface (GUI) for asset scheduling, in accordance with some embodiments.

FIG. 8 illustrates an example of commercial equipment tracking, in accordance with some embodiments.

FIG. 9 is a flowchart of a commercial equipment tracking process, in accordance with some embodiments.

FIG. 10 is a circuit diagram for a state of charge determination circuit, in accordance with some embodiments.

FIG. 11 is a graph showing an example discharge curve of a coin cell battery, in accordance with some embodiments.

### DETAILED DESCRIPTION

In the following description, specific details are set forth to provide illustrative examples of the systems and techniques described herein. The presented concepts may be practiced without some, or all, of these specific details. In other instances, well known process operations have not been described in detail to avoid unnecessarily obscuring the described concepts. While some concepts will be described with the specific examples, it will be understood that these examples are not intended to be limiting.

Some implementations of the disclosed systems, apparatus, methods and computer program products are configured for implementing commercial asset tracking systems. The commercial asset tracking systems described herein allow for commercial assets to be tracked by interfacing with user devices and for information related to the assets to be provided via the user devices, according to the techniques described herein. In various embodiments, commercial assets may include, for example, commercial equipment. Such commercial equipment may include heavy equipment (e.g., heavy machinery), tools, light equipment (e.g., handheld equipment), and/or any other such asset that may be helpful for carrying out a project.

Currently, various commercial equipment are tracked by data manually entered by workers or through On-Board Diagnostics II (OBD II) ports for vehicles. Accordingly, tracking of commercial equipment is arduous and labor intensive. Tracking via OBD II ports is limited to equipment that includes such ports, such as vehicles. The options for tracking commercial equipment are, thus, limited in both functionality and options.

Described herein are systems and methods for commercial equipment trackers, status trackers, and job readiness platforms. The systems and methods described herein provide an interface that allows companies, such as companies with commercial equipment, to schedule, track, execute, and monitor their daily operations and equipment. The commercial equipment tracker described herein allows for tracking of the location and status of the commercial equipment. The commercial equipment tracker described herein also provides an interface for users to access information about the equipment or update the information of the equipment and/or update the status of equipment.

The commercial equipment tracker described herein provides a portable digital tracking tag that is configured to be affixed to commercial equipment. The commercial equipment tracker may include sensors, processors, and memories to allow the tracker to obtain information, usage, conditions, and history for the equipment. The tracker may include one or more communications modules that may provide data packets to a mobile device, such as a user's mobile device. The data packets may, for example, provide a unique identifier associated with the tracker or equipment, indicate the location of the tracker, and/or indicate the status of the commercial equipment. An application on the mobile device may then relay various data provided by the tracker, such as the location information, time, and status data associated with the commercial equipment to a server device.

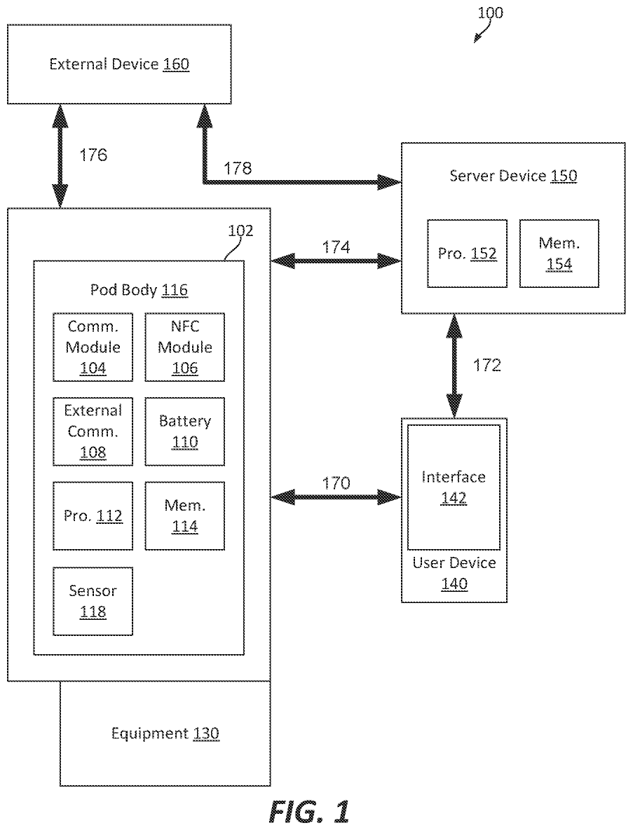

FIG. 1 illustrates a block diagram of an example system, in accordance with some embodiments. FIG. 1 illustrates system 100 configured to track the location, status, and conditions of commercial equipment, as well as for scheduling usage of the commercial equipment. It is appreciated that, for the purposes of this disclosure, when an element includes a plurality of similar elements distinguished by a letter following the ordinal indicator (e.g., “116A” and “116B”) and reference is made to only the ordinal indicator itself (e.g., “116”), such a reference is applicable to all the similar elements.

System 100 includes tracking pod 102 coupled to commercial equipment 130 via housing 120, user device 140, server device 150, and external device 160. Various portions of system 100 may be communicatively coupled via any wired and/or wireless data connection, such as via communications channel 170, communications channel 172, communications channel 174, communications channel 176, and communications channel 178. Such communications channels may be, for example, a wired Ethernet connection or a wireless connection such as WiFi, 3G, 4G, 5G, or another such connection that allows for data to be transmitted. In various embodiments, the various components of the systems described herein may utilize one, some, or all such data connections to communicate and/or receive the various data described herein.

Tracking pod 102 includes communications module 104, NFC module 106, external communications module 108, battery 110, processor 112, memory 114, and sensor 118. Each of communications module 104, NFC module 106, external communications module 108, battery 110, processor 112, and memory 114 may be disposed within pod body 116.

Communications module 104 may be a short ranged communications module that is configured to connect with a user device, such as user device 140, to provide data to the user device. Thus, communications module 104 may be, for example, a module configured to communicate via Bluetooth®, Bluetooth Low Energy (BLE), ultra-wideband (UWB), and/or other such communications protocols that allow for devices to communicate data within a range of, for example, 150 meters or less or within a few miles (e.g., via LoRa).

In various embodiments, communications module 104 may include one or a plurality of different modules to, for example, allow for communication between tracking pod 102 and user device 140 via a plurality of different protocols. For example, communications module 104 may include a beacon module, such as a BLE beacon, that allows for user device 140 to determine the proximity of tracking pod 102 to user device 140. Accordingly, such a beacon module may allow for user device 140 to find tracking pod 102 or detect when tracking pod 102 is within a close range (e.g., 150 meters or less) of user device 140 and provide an alert when tracking pod 102 is within such a range and/or has moved outside of such a range. Beacon module may also allow for determination of the approximate range that tracking pod 102 is away from user device 140. Thus, such a beacon module, when detected by a plurality of user devices, may allow for triangulation to determine the location of the beacon module and, thus, tracking pod 102. Such triangulation may be performed between the devices themselves and/or may be performed by server device 150 utilizing data received from the various user devices. Furthermore, communications module 104 may provide information, usage, conditions, history, and/or other data that is associated with commercial equipment 130.

In another embodiment, communications module 104 may include a UWB module that communicates through the UWB spectrum to allow for more precise locating of tracking pod 102 by user device 140. Thus, UWB module allows for accurate location in three-dimensions by user device 140. In various embodiments, UWB module may provide a shorter range than a BLE beacon, such as a range of 75 meters or less. Accordingly, both a BLE beacon and a UWB module may be utilized in various embodiments of communications module 104.

Such a UWB module may allow for tracking and/or location of equipment within a large jobsite. Certain jobsites may be, for example, up to several square kilometers in size. Equipment may be moved around the jobsite. Thus, for example, a fork lift may be charged in one location and utilized in another location on the jobsite. The UWB module may allow for tracking of the equipment within various portions of the jobsite, simplifying receipt of information, scheduling, and obtaining location details.

Thus, for example, user device 140 may provide a request for precise tracking of tracking pod 102. The precise tracking may be via the UWB module. Upon receipt of such a request, tracking pod 102 may activate the UWB module and the UWB module may communicate with user device 140. Precise tracking of tracking pod 102 by user device 140 may then be accomplished via data from the UWB module.

NFC module 106 may be a module that allows for tracking pod 102 to communicate with user device 140 via Near-Field communication protocols. In various embodiments, NFC module 106 may allow for tracking pod 102 to easily pair with user device 140. Pairing of tracking pod 102 to user device 140 allows for data to be communicated between tracking pod 102 and user device 140. NFC module 106 may also allow for tracking pod 102 to communicate data associated with commercial equipment 130 (e.g., data directed to the status of commercial equipment 130) to tracking pod 102 and/or interface with commercial equipment 130 to determine the status, condition, and/or usage of commercial equipment 130.

Thus, for example, NFC module 106 may, in certain embodiments, allow for user device 140 to identify commercial equipment 130 by communicatively coupling with NFC module 106. Once communicatively coupled, NFC module 106 may provide information, usage, conditions, history, and/or other data that is associated with commercial equipment 130.

External communications module 108 may be a communication module configured to interface with one or more external devices, such as external device 160. External device 160 may be, for example, a global positioning system (GPS) satellite, a cellular tower, or another such device configured to provide data to tracking pod 102. External device 160 may, thus, allow for data to be communicated between tracking pod 102 and server device 150 without data being communicated to user device 140 (e.g., by providing location data for cellular towers to determine the location of tracking pod 102 and provide the determined location to server device 150). Alternatively or additionally, external device 160 may provide location data to tracking pod 102 (e.g., GPS data). Accordingly, tracking pod 102 may communicate with external device 160 via communications channel 176 and external device 160 may communicate with server device 150 via communications channel 178. External device 160 may also provide firmware updates or obtain status data automatically from various tracking pods and relay such data to server device 150 so that such data may be processed and, if necessary, notifications may be provided to a user (e.g., when certain equipment has moved outside of a zone where the equipment is intended to be within).

Memory 114 may be any type of memory device configured to store data and/or instructions. Memory 114 may be, for example, a harddrive, a solid state device, and/or random access memory (RAM) and may include transitory or non-transitory computer-readable media. Memory 114 may be configured to store instructions for performing the techniques described herein, configured to store commercial equipment data (e.g., data associated with the status of commercial equipment 130), and/or configured to store other such data.

Processor 112 may be a single or multi-core processor. As described herein, processor 112 may be configured to perform various operations as described herein. Accordingly, for example, processor 112 may cause data to be communicated from tracking pod 102 to user device 140 for tracking of commercial equipment 130. Processor 112 may be any type of single or multi-core processor that allows for electronic data processing. It is appreciated that processor 112 may perform the techniques described herein utilizing one or more databases, modules, and/or other system components as described herein. Accordingly, processor 112 may perform the techniques described herein while calling upon data stored within memory 114 and/or utilizing the data of one or more modules described herein.

Battery 110 may be a battery configured to store electrical power for powering tracking pod 102. Electrical power from battery 110 may be provided to the various components of tracking pod 102 through various electrical circuits. In various embodiments, a state of charge of battery 110 may be determined through various circuit configurations described herein.

Sensor 118 may be, for example, one or more temperature sensors, accelerometers, gyroscopes, strain detectors (e.g., strain gauges), piezoelectric sensors, magnetic sensors, and/or other such sensors. Variously, sensor 118 may be fully contained within pod body 116 and/or may interface (e.g., contact) portions of commercial equipment 130.

In various embodiments, sensor 118 may be configured to, for example, determine ambient environmental conditions and/or movement of tracking pod 102 that is indicative of movement of commercial equipment 130. Thus, for example, sensor 118 may be configured to determine the acceleration, jerk, velocity, and/or vibrations. Sensor 118 may be configured to determine the magnitude and/or frequency of the movement. Sensor data from sensor 118 may be provided to, for example, processor 112 of tracking pod 102.

Processor 112 may accordingly utilize the sensor data to determine various aspects of commercial equipment 130. For example, processor 112 may determine that commercial equipment 130 is being operated and determine the additional operation cycles (e.g., from sensor data indicating the movement or vibration of commercial equipment 130) imparted to commercial equipment 130. Such data may allow for tracking pod 102 to update the number of operation cycles that commercial equipment 130 has been subjected to. Processor 112 may also determine from, for example, acceleration or velocity data the movement of commercial equipment 130 (e.g., from a location where commercial equipment 130 is typically housed within, such as a hanger or a drawer). Such a change in location may be communicated to user device 140 to provide more accurate information as to the location of commercial equipment 130.

In certain embodiments, input may be provided to tracking pod 102 (e.g., to processor 112 and stored within memory 114) of the type or category of equipment of commercial equipment 130. Based on the type or category of equipment, sensor 118 may be configured to track various aspects of commercial equipment 130. Thus, for example, the user may provide, via user device 140, that commercial equipment 130 is a tool with a limited amount of cycle life. Accordingly, sensor 118 may be configured to determine movement and/or acceleration of commercial equipment 130 indicative of a load cycle for the tool and, based on the amount of load cycles detected by sensor 118, the status of commercial equipment 130 may be updated. Thus, in various embodiments, data directed to the status of commercial equipment 130 may be stored within memory 114, may be provided to user device 140 and stored within memory of user device 140 and/or communicated to server device 150 for storage. Based on the data from sensor 118, such stored data may be accordingly updated and, thus the status of commercial equipment 130 may be updated.

In another such embodiment, data from sensor 118 may indicate when commercial equipment 130 is being operated and, based on such a determination, the operational hours of commercial equipment 130 may be dated. In a further such embodiment, data from sensor 118 may indicate that commercial equipment 130 is being utilized or located in the area of operation of various operators and, accordingly, the operators that have used the specific commercial equipment 130 may also be updated. Furthermore embodiments may, for example, detect the environmental conditions, such as temperature and pressure (e.g., via temperature or pressure sensors), that commercial equipment 130 has been subjected to. Thus, if commercial equipment 130 has been subjected to temperatures beyond its operating envelope, the status of commercial equipment 130 may be changed to “non-operational.”

Pod body 116 may be, for example, any type of external body that can be configured to contain the components of tracking pod 102 and allow for tracking pod 102 to be held by a user. Thus, pod body 116 may be a case for the components of tracking pod 102 that is made from plastic, composites, metal, rubber, and/or other materials.

Pod body 116 may be configured to be disposed within housing 120. Accordingly, housing 120 may include a cavity that may be shaped to receive pod body 116. Pod body 116 may, in certain embodiments, be configured to be snugly held within the cavity of housing 120. Housing 120 may be a housing made from plastic, composites, metal, rubber, and/or other materials and may provide a durable outer covering for tracking pod 102 to prevent damage to tracking pod 102 (e.g., from operation of various commercial equipment around tracking pod 102).

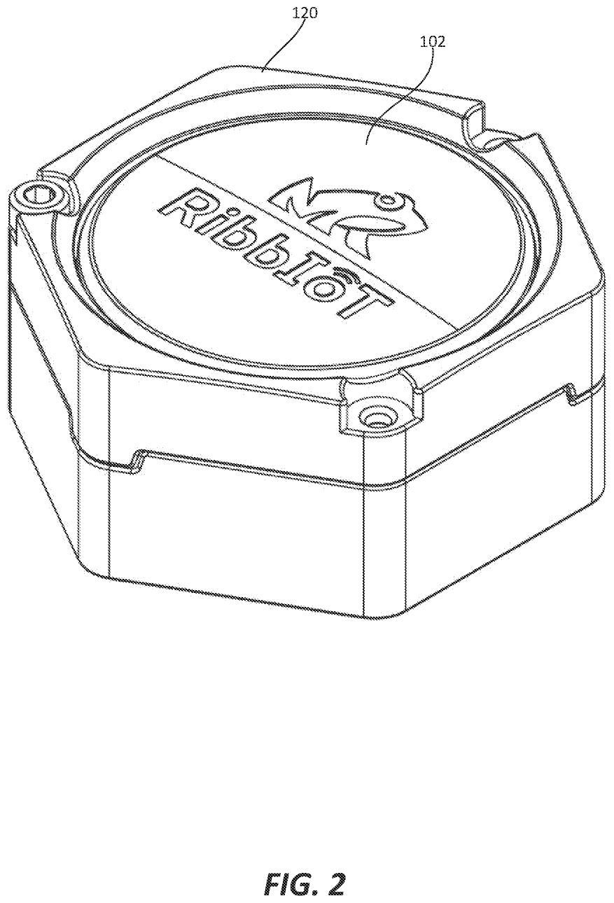

Various features of tracking pod 102 may be described in conjunction with FIG. 2. FIG. 2 illustrates a perspective view of a commercial equipment tracking assembly, in accordance with some embodiments. As shown in FIG. 1 and FIG. 2, tracking pod 102 may be disposed within housing 120. Housing 120 may be configured to couple to commercial equipment 130. In various embodiments, housing 120 may be configured to couple to commercial equipment 130 via one or more different techniques, such as through bolting, screwing, welding, adhesives, and/or other such techniques. As such, housing 120 may be securely coupled to commercial equipment 130 and may minimally move when coupled to commercial equipment 130. In certain embodiments, a plurality of different form factors may be utilized for housing 120. Different form factors may be used to contain components of tracking pod 102 and specific form factors may be utilized for specific applications. Thus, for example, a relatively flat housing 120 may be utilized for heavy construction equipment that has flat sides, while a housing 120 that includes a form factor for conforming to a handle of a tool may be utilized for tools.

Commercial equipment 130 may be any type of commercial equipment, including handheld equipment such as tools and bits, heavy equipment such as vehicles, raw materials, and/or other such commercial equipment. In various embodiments, commercial equipment 130 may be shared equipment, such as equipment shared within a company or firm, or rental equipment. Commercial equipment 130 may be shared between different jobs and/or sites and may be moved between those jobs and/or sites depending on project need.

User device 140 may be a user device of a user utilizing tracking pod 102 to track the location and/or status of commercial equipment 130. User device 140 may be, for example, desktop computing devices, portable computing devices (e.g., laptops, tablets, smartphones, and/or other electronic devices), wearable devices, and/or other such electronic devices. User device 140 may include interface 142, which may be configured to provide data (e.g., visual, haptic, and/or audio data that may indicate the location and/or status of tracking pod 102) to the user. Interface 142 may also be configured to receive inputs from the user and provide data associated with the inputs (e.g., commands such as requests for data) to tracking pod 102 and/or server device 150. In various embodiments, a plurality of user devices associated with one or more users may be communicatively coupled to tracking pod 102 and/or server device 150 and each user device 140 may be configured to track the location of tracking pod 102 if the user device is within range of tracking pod 102. Data may be communicated between tracking pod 102 and user device 140 via communications channel 170.

In various embodiments, user device 140 may be configured to scan tracking pod 102 and determine details of the equipment that tracking pod 102 is coupled to. For example, user device 140 may scan tracking pod 102 to determine the maintenance that is due to be performed on equipment 130. Once maintenance has been performed, user device 140 may also scan tracking pod 102 to indicate that the maintenance has been performed. Such a technique may reduce paper trail requirements.

Server device 150 may be a server system that operates as one computing device or a plurality of devices. Server device 150 may be, for example, an application server, a database server, a client system such as a laptop, desktop, smartphone, tablet, wearable device, set top box, etc., or any other device or service described herein. Server device 150 may include processor 152 and memory 154. Memory 154 may include one or more databases that may provide data to user device 140 via communications channel 172 (e.g., in response to requests for data from user device 140). Processor 152 may be configured to perform operations of server device 150, as described herein. Furthermore, server device 150 may receive data (e.g., location data) from tracking pod 102 and/or provide data (e.g., instructions) to tracking pod 102 via communications channel 174. Server device 150 may also provide data to user device 140 to, for example, allow for scheduling of commercial equipment 130 (e.g., to be used by various users of commercial equipment 130, such as between different jobsites). In certain such embodiments, communications channel 174 may be a communications channel providing data through, for example, a cellular network.

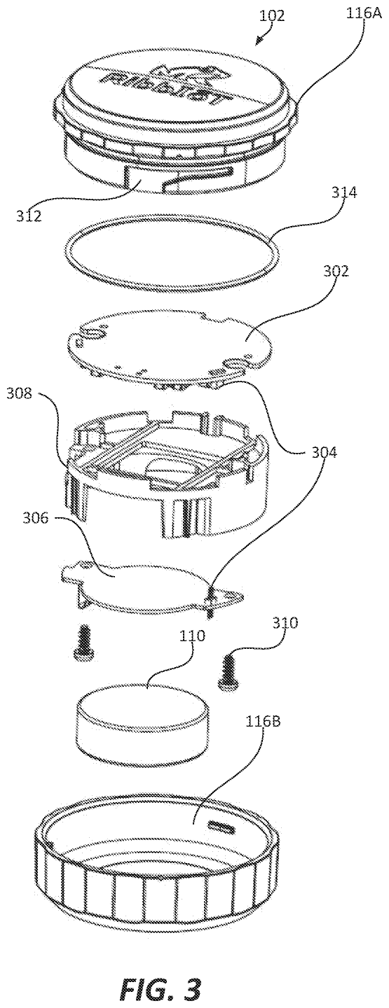

FIG. 3 illustrates an exploded view of a commercial equipment tracking device, in accordance with some embodiments. The exploded view of FIG. 3 illustrates various components of tracking pod 102, including PCB module 302, board to board connectors 304, PCB 306, battery holder 308, battery 110, screws 310, pod bodies 116A and 116B, and gasket 314.

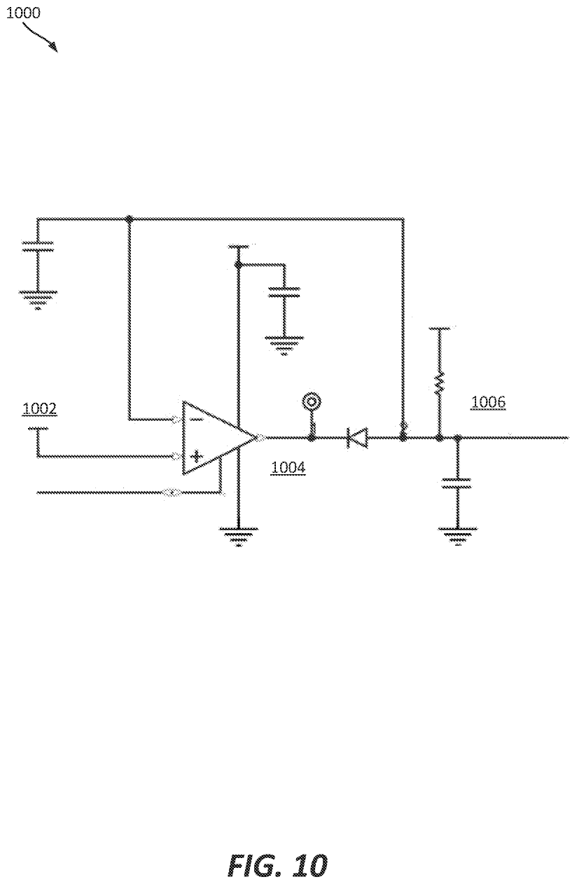

PCB module 302 may include a PCB board, various components such as processor, memories, and other computing components, and a board to board connector 304 for communicatively coupling with PCB 306. PCB 306 may also include a board to board connector 304 configured to couple to the connector of PCB module 302. PCB 306 may be, for example, a battery PCB for operation of battery 110. For example, PCB 306 may include circuitry for determining a state of charge of battery 110. Such circuitry may be further described in FIG. 10.

Battery 110 may be configured to power tracking pod 102. Battery 110 may be held by battery holder 308. The various internal components of tracking pod 102 (e.g., PCB module 302, PCB 306, and/or battery holder 308) may be coupled together with various fasteners, such as screws 310 as well as, as non-limiting examples, clips, adhesives, snap fasteners, and/or other such fasteners.

Pod body 116 may house the internal components of tracking pod 102. Pod body 116 may include pod bodies 116A and 116B, which may be coupled and secured together (e.g., via locking feature 312) to form an outer housing of tracking pod 102. Pod body 116 may be composed of any appropriate material and locking feature 312 may allow for locking together of pod bodies 116A and 116B. Thus, for example, locking feature 312 may be a twist lock, a mechanical fastener such as a screw, chemical of adhesive fasteners, welding, and/or another such together to couple together pod bodies 116A and 116B. Gasket 314 may be disposed to prevent the intrusion of moisture, dust, and/or other foreign objects into the inner cavity of tracking pod 102 formed by pod bodies 116A and 116B.

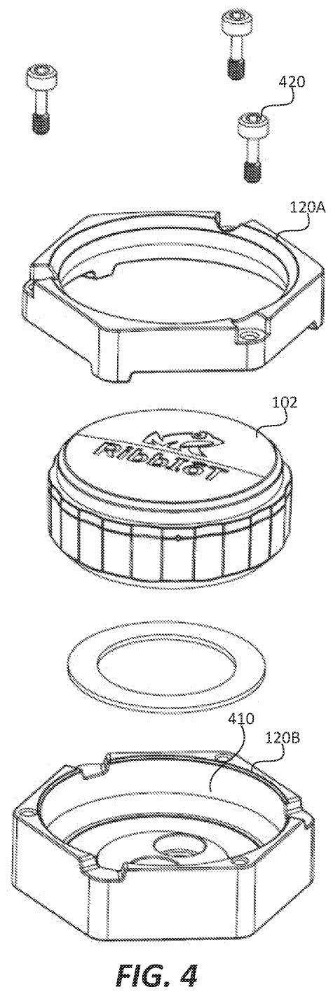

FIG. 4 illustrates an exploded view of components of a commercial equipment tracking assembly, in accordance with some embodiments. As shown in FIG. 4, tracking pod 102 may be disposed between housings 120A and 120B. Tracking pod 102 may be disposed within cavity 410 of housing 120. In various embodiments, cavity 410 may be shaped to snugly receive tracking pod 102 and allow for no (e.g., where housing 120 is nestled within a deformable material within cavity 410 such as padding) or minimal (e.g., less than 5 mm of movement before contact) movement of tracking pod 102 within cavity 410.

In the embodiment shown in FIG. 4, housing 120 may be a two part housing that is configured to be coupled together when tracking pod 102 is disposed within cavity 410. Housing 120A and 120B may be coupled together according to any appropriate temporary or permanent technique, such as via screws 420, adhesives, forms such as snaps, clips, welding, and/or other such techniques.

In certain embodiments, housing 120 may be configured to couple to commercial equipment 130. Such coupling may also be via any appropriate temporary or permanent technique (e.g., screws, bolts, adhesives, forms such as snaps, clips, welding, and/or other such techniques). If housing 120 is permanently coupled to commercial equipment 130 in such a manner where removal may be difficult, the two part configuration of housing 120 may allow for tracking pod 102 to nonetheless be removed and associated with another piece of commercial equipment.

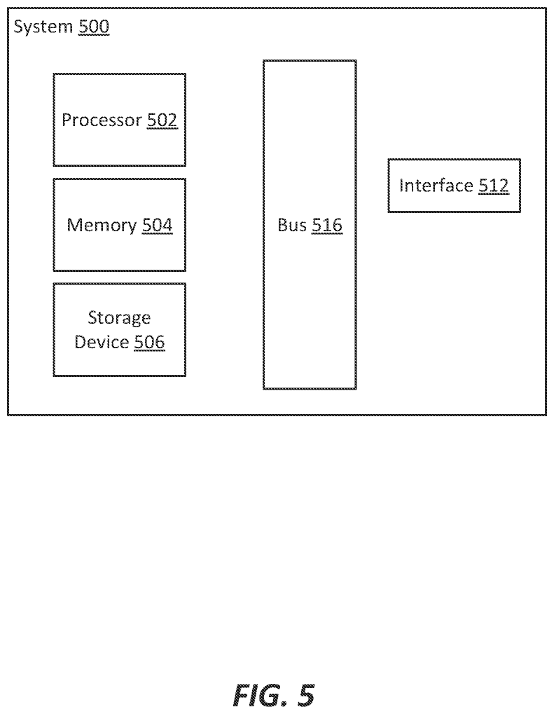

FIG. 5 illustrates a block diagram of an example computing system, in accordance with some embodiments. According to various embodiments, a system 500 suitable for implementing embodiments described herein includes a processor 502, a memory module 504, a storage device 506, an interface 512, and a bus 516 (e.g., a PCI bus or other interconnection fabric.) System 500 may operate as variety of devices such as a server system such as an application server and a database server, a client system such as a laptop, desktop, smartphone, tablet, wearable device, set top box, etc., or any other device or service described herein.

Although a particular configuration is described, a variety of alternative configurations are possible. The processor 502 may perform operations such as those described herein. Instructions for performing such operations may be embodied in the memory 504, on one or more non-transitory computer readable media, or on some other storage device. Various specially configured devices can also be used in place of or in addition to the processor 502. The interface 512 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed embodiments may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

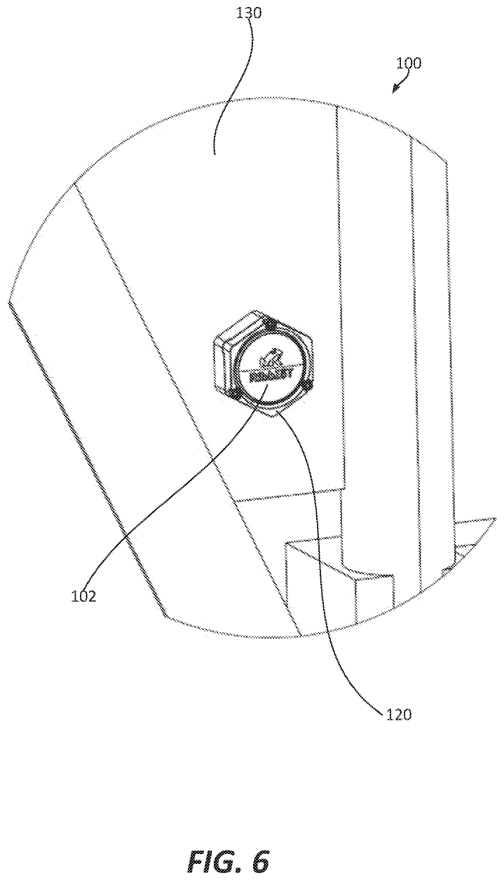

FIG. 6 illustrates a commercial equipment tracking device affixed to commercial equipment, in accordance with some embodiments. FIG. 6 illustrates an example of system 100 that includes tracking pod 102 disposed within housing 120. Housing 120 is coupled to commercial equipment 130. As shown, housing 120 is directly coupled to commercial equipment 130 via any of the techniques described herein. Tracking pod 102 may be disposed within housing 120 and may be removed from housing 120 without decoupling housing 120 from commercial equipment 130.

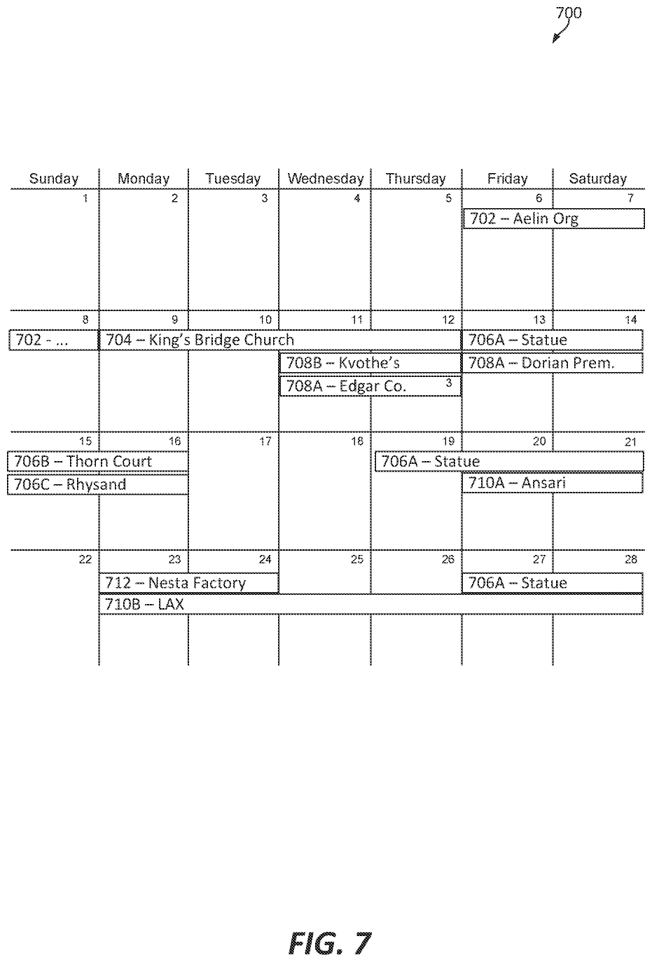

FIG. 7 illustrates a graphical user interface (GUI) for asset scheduling, in accordance with some embodiments. FIG. 7 illustrates GUI 700 that includes various GUI elements indicating scheduling of commercial equipment. Each separate numbered element of GUI 700 may correspond to a specific type of commercial equipment.

As shown, GUI 700 includes element 702, which may be a type of equipment that is scheduled to be deployed to Aelin Org. Element 704 may be a type of equipment different from element 702 that is scheduled to be deployed to King's Bridge Church. Element 712 may be equipment that is scheduled to be deployed to Nesta Factory.

Elements 706, 708, and 710 may correspond to types of equipment that are scheduled to be deployed to a plurality of different sites and/or where there are a plurality of different quantities of the same type of equipment for scheduling. For example, element 706A may be a first piece of the type of equipment of element 706 and may be deployed to Statue for three non-consecutive periods. Elements 706B and 706C may correspond to different pieces of the same type of equipment as element 706A.

Element 708 may include two different pieces of the same type of equipment. Element 708A may first be deployed to Edgar Co. and then deployed to Dorian Prem. Element 708B may be scheduled to be deployed to Kvothe's. Similarly, element 710A may be scheduled to be deployed to Ansari while element 710B may be scheduled to be deployed to LAX.

In various embodiments, GUI 700 may be presented based on data and analysis performed by server device 150. Server device 150 may, for example, allow for optimization in scheduling the delivery and/or availability of various pieces of equipment between a plurality of different jobsites, via GUI 700 and/or another such interface. Thus, for example, server device 150 may receive data from various tracking pods, such as tracking pod 102. Based on the data received from the various tracking pods, server device 150 may coordinate the sharing of a limited amount of commercial equipment between a plurality of jobsites and projects (e.g., in a situation where the number of jobsites and/or projects is greater than the amount of available commercial equipment).

Thus, for example, server device 150 may determine that various locations and times of availability for the pieces of commercial equipment tracked by tracking pods. Based on the locations of the commercial equipment and the current project schedule, server device 150 may then determine availability of the various pieces of commercial equipment and various additional projects that require the commercial equipment. Server device 150 may match portions of the schedule where various commercial equipment is available with the needs of various projects. In certain embodiments, server device 150 may provide a buffer for the transport of commercial equipment (e.g., a buffer of 1 day, 2 days, or various amounts of time dependent on the estimated travel distance/time).

In certain embodiments, server device 150 may additionally determine the potential usage of commercial equipment for the various projects (e.g., the likely amount of hours or cycles placed on the equipment during the project). Server device 150 may then match the potential usage with the commercial equipment of appropriate status. Thus, for example, server device 150 may determine that a project requires a first type of commercial equipment, of which two different pieces exist in a company's inventory. Server device 150 may additionally determine that the project requires 100 hours of usage for the commercial equipment and that the first piece has a usable remaining life of 50 hours while the second piece has a usable remaining life of 200 hours. Based on such a determination, server device 150 may select the second piece for scheduling for the project, even if the first piece is logistically less challenging to deliver.

In certain embodiments, various assets and/or devices may be grouped together for tracking. For example, certain users, projects, and/or jobsites may each be associated with a specific group of assets (e.g., equipment) that, for example, are typically or always needed by the user, project, and/or job site. Such groupings may be scheduled as a group and tracked separately or as a group.

In various embodiments, in addition to scheduling, tracking of assets and equipment through the technique shown in GUI 700 allows for accurate quoting of projects based on determining what assets or equipment are available for the project and through confirmation based on historical data. Additionally or alternatively, due to the location of the assets being tracked, environmental conditions, such as weather, may be determined based on location information or ambient conditions detected through various sensors of the tracking pod. Such environmental conditions may allow for the adjustment of scheduling (e.g., due to environmental conditions) of the equipment or assets.

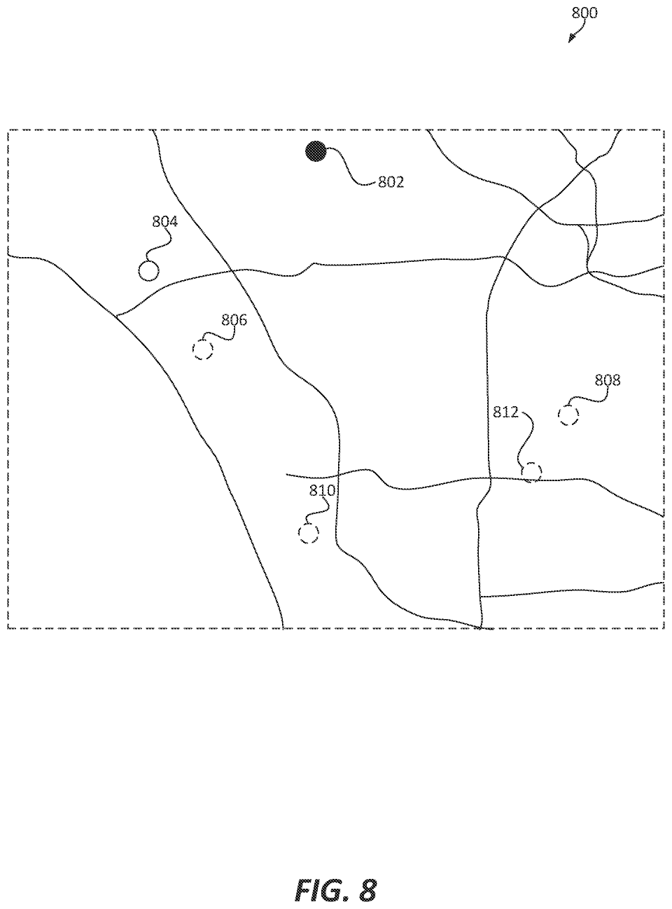

FIG. 8 illustrates an example of commercial equipment tracking, in accordance with some embodiments. FIG. 8 illustrates GUI 800, which is a GUI illustrating the various associated locations of commercial equipment. GUI 800 may communicate the status of various equipment bookings. For example, GUI 800 may include elements 802-812. Element 802 may be a scheduled job with equipment scheduled to be delivered in the future. Element 804 may be a completed job. For element 804, the commercial equipment may still be remaining on site, but may no longer be needed, or the equipment may have been removed. Meanwhile, elements 806-812 may be ongoing jobs. The ongoing jobs of elements 806-812 may have equipment that has been delivered, is scheduled to be delivered, or has the portion of the job that requires the equipment already completed.

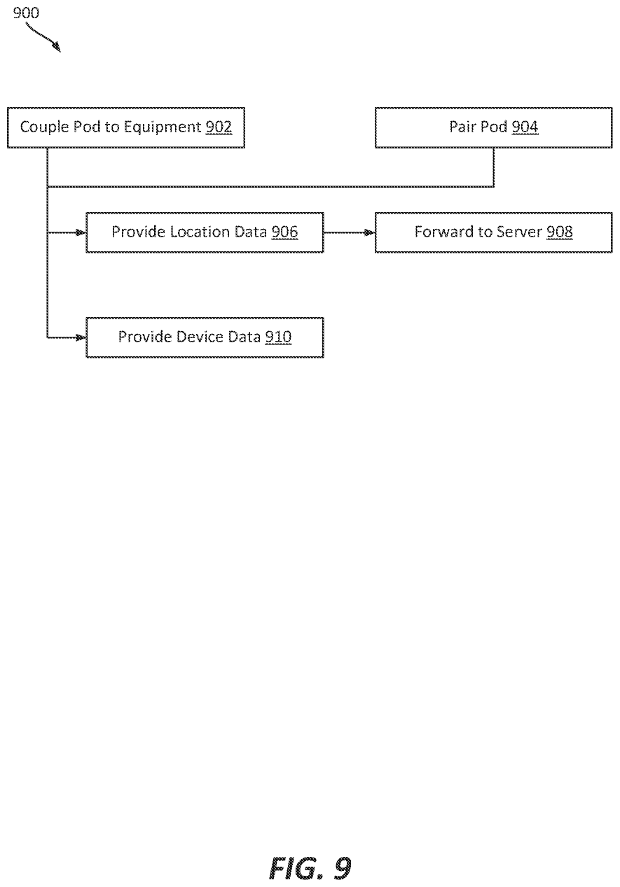

FIG. 9 is a flowchart of a commercial equipment tracking process, in accordance with some embodiments. FIG. 9 includes flowchart 900 that details the operation of a tracking pod, according to the techniques described herein.

In 902, the tracking pod may be coupled to the commercial equipment. Coupling of the pod to commercial equipment may be via direct coupling (e.g., screwing, clipping, adhering, and/or any other technique that couples the tracking pod to the commercial equipment) and/or coupling via a housing configured to receive the tracking pod. For embodiments where the coupling is via a housing, the housing may include a cavity configured to receive the tracking pod and securely hold the tracking pod. The tracking pod may then be coupled to the commercial equipment according to the techniques described herein.

In 904, the tracking pod may be paired to a user device. Pairing of the tracking pod to the user device allows for the tracking pod and the user device to communicate data. Various embodiments may allow for data communicate in one direction or in both directions. Pairing of the user device may be via WiFi, NFC, Bluetooth, and/or any other communications format.

In 906, location data may be provided from the tracking pod to the user device. In various embodiments, such location data may be provided as data according to Bluetooth (e.g., BLE), UWB, NFC, and/or other such communication formats. The location data may be data indicating or allowing for the determination of the distance of the tracking pod from the user device (e.g., within 150 meters), data indicating the actual location (e.g., latitude and longitude) of the tracking pod, data indicating the detected amount of travel of the tracking pod from a predetermined holding location, and/or another such data associated with the location of the tracking pod. In various embodiments, the user device may then forward the received data to the server In 908.

In various embodiments, the tracking pod may determine the location of the tracking pod itself (e.g., from GPS data) and forward the determined location to the server instead of the raw location data. Thus, for example, the user device may determine the GPS coordinates of the tracking pod or the actual location of the tracking pod based on the location data indicating the distance of the tracking pod from the user device and/or the location of the user device itself (e.g., based on GPS data received by the user device). Such determinations may then be forwarded to the server.

In other embodiments, the actual data received by the user device may be provided to the server. The server may then utilize the data to, for example, make one or more determinations as to the status and/or location of the commercial equipment. For example, in certain embodiments, such as embodiments where the tracking pod provides data directed to distance from the user device, a plurality of user devices may receive such data and each user device may forward such data to the server. The server may then determine the triangulated position of the tracking pod from the data received from the plurality of devices. Such data may then be communicated back to the user device(s) to indicate the actual location of the tracking pod. In another example, the location data of the tracking pod may be encrypted and such encrypted data may be forwarded to the server for security reasons. The server may only provide the location of the tracking pod to authenticated user devices upon request, for security reasons.

In 910, device data from the tracking pod may also be provided to the user device. Such device data may be data directed to the commercial equipment that the tracking pod is coupled to. Thus, for example, the condition, status, cycle, type, user instructions, and/or other such data of the commercial equipment may be provided to the user device by the tracking pod. In various embodiments, such data may be provided via, for example, NFC. However, other embodiments may provide such data via other communication protocols, such as BLE or UWB. The device data may then be communicated by the user device to a user (e.g., displayed and/or communicated audibly).

In various embodiments, battery 110 of tracking pod 102 may be a coin cell battery. Typically, products that are powered by coin cell batteries do not provide a reliable state of charges (e.g., remaining battery capacity) with granularity as a battery's state of charge is typically determined from the voltage of the battery. Coin cell batteries have a very flat voltage profile as they discharge, meaning that there is barely any discernible voltage difference as coin cell batteries discharge; noise would actually be a bigger factor in the detected voltage difference. Instead, for devices utilizing coin cell batteries, only a battery low state warning is provided. When coin cell batteries are almost depleted (e.g., with less than 10% remaining charge), the voltage then drops precipitously, which then triggers the low state warning in typical coin cell operated devices.

FIG. 10 is a circuit diagram for a state of charge determination circuit, in accordance with some embodiments. FIG. 10 illustrates circuit 1000 that allows for a granular determination of a coin cell battery (e.g., such as battery 110) state of charge.

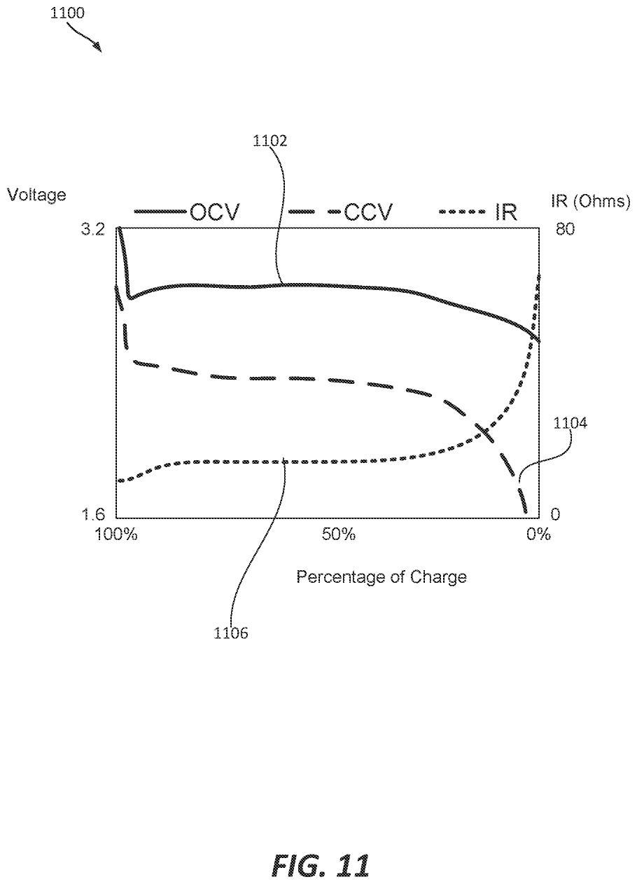

Typically, a coin cell battery's state of charge is not able to be reliably determined as a battery's state of charge is generally determined based on voltage drop from a threshold. Coin cell batteries have a very flat discharge curve, as shown in discharge curve 1102 of FIG. 11. FIG. 11 is a graph showing an example discharge curve of a coin cell battery, in accordance with some embodiments. Discharge curve 1102 is the discharge curve for open circuit voltage, which is generally what is used to determine a state of charge of a battery. Due to the flatness of the discharge curve, random noise will introduce greater variations in the voltage of the battery and, thus, the state of charge cannot be reliably determined until the voltage falls off precipitously after 25%. Accordingly, by the time a coin cell battery exhibits significant voltage drop, the battery is typically close to running out of charge. As such, for electronic devices that utilize coin cell batteries, granular state of charges are typically not shown and only an indicator or message to replace the battery, when it is near fully discharged, is provided.

However, in general, coin cell batteries have high internal resistance that changes more greatly over a discharge cycle than voltage and allow for a more granular determination of the battery state of charge. Nonetheless, just the internal resistance may not provide enough granularity to reliably determine the state of charge of a coin cell battery.

Circuit 1000 is configured to determine the voltage drop of battery 110 to calculate the internal resistance of battery 110. Circuit 1000 may be electrically coupled to battery 110 for measurement of the state of charge of battery 110.

Variously, circuit 1000 may determine the battery state of charge by determining the open circuit voltage from input 1002 and the closed circuit voltage from output 1006. Furthermore, the temperature of battery 110, whether ambient or the battery temperature, may be determined from sensors of battery 110 and/or sensor 118. The open circuit voltage, the closed circuit voltage, temperature, and/or the internal resistance may allow for sufficient datapoints to determine the battery state of charge by comparing to or curve fitting to, for example, the example discharge curve of a coin cell battery shown in FIG. 11 (e.g., open circuit discharge curve 1102, closed circuit discharge curve 1104, and internal resistance curve 1106). Thus, for example, the open and closed circuit voltages and the internal resistance (which may be calculated based on the difference between the open circuit voltage and the closed circuit voltage) may allow for a determination of the state of charge of the battery.

The voltage drop (e.g., difference between open and closed circuit voltage) for circuit 1000 is determined due to the pulsing of communications module 104. For example, a Bluetooth module (e.g., a BLE module) regularly pulses battery 110 with a known current. Typically, the closed circuit voltage is a voltage that can only be measured when there is a load on the battery (e.g., when the battery is being discharged). Thus, for example, the closed circuit voltage may be measured when BLE module is operating (e.g., pinging) and, thus, there is a current being pulled from battery 110. However, when the BLE module is operating, processor 112 is typically performing operations for tracking and, thus, does not have sufficient resources to measure the closed circuit voltage. Utilizing a more powerful processor would result in a higher unit cost and, possibly, a larger form factor.

Operational amplifier 1004 of circuit 1000 is configured to equalize its input and output. Input 1002 is electrically coupled to the BLE module and, when the BLE module is operational, there is a voltage drop within battery 110 due to the electric load of operating the BLE module and, thus, the voltage across input 1002 is equal to the closed circuit voltage (e.g., of curve 1104 of FIG. 11). Op amp 1004 would then equalize voltage between input 1002 and output 1006 and, thus, the voltage across output 1006 would also equal the closed circuit voltage. Nonetheless, as described herein, processor 112 may not have the resources at the time of BLE module operation to measure the closed circuit voltage.

In circuit 1000, output 1006 includes a resistor and a capacitor. The resistor and capacitor operate as a large filter and, thus, even when the voltage across input 1002 returns to the open circuit voltage, the resistor and capacitor only allow the voltage across output 1006 to very slowly return to the open circuit voltage (e.g., over a period of 10 seconds up to multiple minutes). Accordingly, the resistor and capacitor effectively functions as a memory of the voltage and the voltage across output 1006 is held around that of the closed circuit voltage for a large period of time, enough for processor 112 to have free resources to measure the voltage across output 1006 and, thus, measure the closed circuit voltage (e.g., as BLE module is no longer operating, processor 112 may accordingly have the spare resources to measure the voltage across output 1006). Thus, circuit 1000 allows for a processing resource limited device (e.g., tracking pod 102) to measure both the open and closed circuit voltage, with the closed circuit voltage measured at a time period when there is no or minimal flowing current. As the current is also known, determination of the open and closed circuit voltages allows for the determination of the internal resistance of battery 110 (e.g., via Ohm's Law, V=IR) and, thus, the state of charge of battery 110 by comparing the measured open circuit voltage, the measured closed circuit voltage, and the determined internal resistance and comparing those measurements and determinations to the curve of the specific battery (e.g., curves 1100 of FIG. 11)

Accordingly, circuit 1000 allows for the calculation of the internal resistance of tracking pod 102 based on 1) the open circuit voltage measured at input 1002, the 2) closed circuit voltage measured at output 1004, and the 3) known current from the pulsing of communications module 104 through Ohm's law (V=IR) as the current is known and the voltage drop is calculated through the readings within circuit 1000. In various embodiments, additional information, such as the current temperature, may be determined by one or more sensors of tracking pod 102 to allow for further accuracy in determining the battery state of charge. A battery state of charge for the coin cell battery of battery 110 may thus be determined with circuit 1000.

In certain embodiments, tracking pod 102 may include both a BLE module and an UWB module. However, the UWB module may only be operated upon request from user device 140. The UWB module may also draw a different amount of current from that of the BLE module. Thus, the technique determining the state of charge by processor 112 utilizing circuit 1000 may be utilized when UWB module is not being operated (e.g., after UWB module has not been operated for at least 1 minute, 5 minutes, 10 minutes, and/or another determined period of time) and may pause when UWB module is being operated.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various embodiments have been described herein, it should be understood that they have been presented by way of example only, and not limitation. For example, some techniques and mechanisms are described herein in the context of fulfillment. However, the disclosed techniques apply to a wide variety of circumstances. Particular embodiments may be implemented without some or all of the specific details described herein. In other instances, well known process operations have not been described in detail in order not to unnecessarily obscure the techniques disclosed herein. Accordingly, the breadth and scope of the present application should not be limited by any of the embodiments described herein, but should be defined only in accordance with the claims and their equivalents.

1. A commercial equipment tracking system, comprising:
a tracking pod, comprising:
a pod body, configured to be coupled to commercial equipment;
a first communications module, disposed within the pod body and configured to connect with a user device to provide equipment data to the user device, wherein the first communications module comprises an ultra-wideband (UWB) module;
a near-field communications module, disposed within the pod body and configured to communicatively couple with the user device when the user device is disposed within a short range of the tracking pod; and
a battery configured to power the first communications module and/or the near-field communications module.

2. The commercial equipment tracking system of claim 1, wherein the pod body is configured to couple to the commercial equipment via a pod housing.

3. The commercial equipment tracking system of claim 2, wherein the pod body is configured to be disposed within a cavity of the pod housing.

4. The commercial equipment tracking system of claim 2, further comprising:
the pod housing.

5. The commercial equipment tracking system of claim 4, wherein the pod housing is configured to fully surround a perimeter of the pod body.

6. The commercial equipment tracking system of claim 1, wherein the equipment data is configured to cause the user device to provide location data to a server device.

7. The commercial equipment tracking system of claim 1, wherein the equipment data is configured to allow the user device to identify the commercial equipment.

8. The commercial equipment tracking system of claim 1, wherein the first communications module is configured to connect to a plurality of user devices to provide equipment data to each of the plurality of user devices.

9. The commercial equipment tracking system of claim 8, wherein the providing the equipment data to each of the plurality of user devices allows triangulation to be performed to determine a location of the tracking pod.

10. The commercial equipment tracking system of claim 1, wherein the equipment data is configured to cause a user interface of the user device to provide information associated with the commercial equipment.

11. The commercial equipment tracking system of claim 1, wherein the first communications module further comprises a Bluetooth Low Energy (BLE) module.

12. The commercial equipment tracking system of claim 1, further comprising:
a sensor, configured to provide sensor data; and
and a memory, configured to receive and store the sensor data.

13. The commercial equipment tracking system of claim 1, wherein the near-field communications module is configured to provide equipment data to the user device.

14. The commercial equipment tracking system of claim 13, wherein the equipment data is configured to cause the user device to communicate device information.

15. The commercial equipment tracking system of claim 1, wherein the tracking pod further comprises:
a global-positioning system (GPS) module, configured to receive location data from one or more GPS satellites.

16. The commercial equipment tracking system of claim 15, wherein the tracking pod further comprises:
a cellular module, configured to provide the location data to the user device.

17. The commercial equipment tracking system of claim 1, further comprising:
a battery voltage monitor, configured to determine a state of charge of the battery based on:
a voltage change of the battery during a communications event of the first communications module;
a current of the battery during the communications event of the first communications module; and
a temperature of the battery.

18. The commercial equipment tracking system of claim 1, further comprising:
a server device, configured to receive equipment data associated with a plurality of commercial equipment from a plurality of user devices associated with a plurality of tracking pods.

19. The commercial equipment tracking system of claim 18, wherein the server device is further configured to:
determine, based on the equipment data, current locations for each of the commercial equipment.

20. The commercial equipment tracking system of claim 19, wherein the server device is further configured to:
determine, based on the current locations of the commercial equipment, an equipment schedule.
